(19) United States
(12) Patent Application Publication
(10) Pub. No.: US 2006/0165250 A1
(43) Pub. Date: Jul. 27, 2006

(54) Meridian rotating acoustic mounts

(76) Inventor: Nicholas Edwin, Tampa, FL (US)

Correspondence Address: Nicholas Edwin, 3911 N. Dartmouth Ave North, Tampa, FL, 33603, US

(21) Appl. No.: 11/042,940

(22) Filed: Jan. 26, 2005

(51) Int. Cl. H04R 1/02

(52) U.S. Cl. 381/386; 381/387

(57) ABSTRACT

The “Double Meridian Rotating Acoustic Mounts” is made up of several major components; two chanalized polygonal shapes or rings and several pegs are placed on opposites sides of the mechanism. When complete it bears the accompaniment of a speaker unit. The mounts are currently being used in the industry today in World globe stands. These which require a spherical ball to be rotated while being supported usually in between the north and South Pole with a peg placed in a quarter moon bracket to support its movement and to allow the globe to spin. The bracket mount then allows the globe to rotate freely while being supported. Currently a speaker unit is widely used in the industry today in home and audio devices to produce sound generated by electromagnetic pulses entering its coils and magnets. The two devices are currently not associated, due to each having a separate function in aspects of mechanics and the other in electronics. The “Double Meridian Rotating Acoustic Mounts” utilizes the two separated field elements and extensively modifies the meridian brackets to combine the fields into a single purpose apparatus.

### BACKGROUND OF THE INVENTION

Since the first speaker invention, innovative designs have been made to maximize sound reproduction. In 1920's, Chester W. Rice and Edward Washburn patentee the prominent design for speakers which incorporated the moving coil and direct radiator. The speakers were sold to the public by the name of “Radiola”. Within its period of time, its sound reproduced was superior to anything previously invented. The unique design lessens distortion and enhanced audio quality.

Other exemplary designs have been made to Subwoofer, Woofers, tweeters, and midrange speakers. Better cooling designs, improved magnets, higher wattage handling, and stronger more rigid materials. All these combinational and exploits in the filed have enable higher fidelity audio reproduction and listening pleasures.

Another integral part of this design is the meridian rings. Many dramatic advances have been accomplished throughout history on the meridian Mounts. Different mounts has been used to accomplish different tasks. Globes and world maps have been the most frequently used products to use the meridian rings effectively.

The meridian ring has evolved to compensate this description of the Invention the “Speaker Mounted in a Double Meridian Rotating Acoustic Mount.”

The “Speaker Mounted in a Double Meridian Acoustic Mounts” as described, uses a combination of modern innovations to achieve and optimize its use. The method used to achieve this rotation is a ring like shape within a ring like shape. These polygonal shapes or rings can be applied to any existing or proposed speaker device. These rings, rotating within each other or a combination of therefore can provide a low friction environment for the speaker to rotate while being played or in a rest state position, on its axis. The proposed devices have quick setup, easy installations and most compatibility with any acoustic suspension systems or bass reflex speaker systems on the market. Any existing enclosures will not interrupt with its calculated intent. Thus the Speaker Mounted on a double meridian ring apparatus adds free movement but non-interference with calculated specs designed for a system. The resulting structure provides a higher efficiency in movement but not depreciation in quality caused by a steady bracing of the speaker.

In this case the rings can essentially provide aesthetics as well as efficiency due to it rotating waveforms produce enhancing vocal ambiance and a multi directional flow of acoustics an every given degree. Agitation by more power being added to the speaker system will aid in its 360-degree self-rotation. Thus cresting more rapid rotation using kinetic energy generated by the speaker. This device can especially be used in smaller environments (ex. Automotive) where a multi-timbrel effect as well as aesthetically pleasing facial skin is needed in a limited space.

U.S. Pat. No. 6,374,942 to Huggins, a patent that provides a system for a combined rotatable and electrical speaker mounting system. This system allows the positioning and re-positioning of a speaker system with full rotational motion of the speaker to direct aim without severing the electrical connection. Huggins speaker assembly is configured for a speaker that suffers from directionality and sound distance attenuation limitations. Huggins speaker assembly is configured with a mechanical mounting mechanism and configured to establish an electrical connection between the speaker and the enclosure. Although Huggins speaker system allows rotation, its rotation is based on fixture like enclosure that is manually rotated and locked to better disburses sounds (in home audio systems) downward. His invention also consists of cylindrical members that are configured to axially concentrically couple with one another, which allows the speaker to have a full range of motion (i.e. when adjusted by user) with respect to the enclosure to be adjusted without using tools to disassemble and rewire the system. But this system is complex and cannot be adapted quickly into an existing car audio or any speaker system, especially with off the shelf components. His speaker apparatus also allows for full directional aiming of the speaker due to the electrical connections and the mechanical connections being independent.

Another unlike comparison can be made with U.S. Pat. No. 5,574,796 to Zeezer, a patent that provides a mounting of a loudspeaker in a room boundary structure having an outside surface away from the inside of the room includes a frame constructed and arranged to rest on the outside surface. Zeezer speaker assembly is configured to mounting a loudspeaker structure in a room by means of spring like construction and arranged to exert a unidirectional force away from the inside of the room whenever the second end of the spring is displaced from the retracted position toward the inside of the room and the extended position. This then free the mechanisms to engage the structure for supporting loudspeaker structure. This system allows the mounting of a speaker but does not resemble the like fashion or intent of the Double Meridian Rotating Acoustic Mounts which mounts on an independent polygon enclosed in another independent polygonal shape, after encompassing and audio replication device therefore providing audio sound, which purpose IS to rotate on both (North and/or South) meridians when power is applied in a free form manner. Keezer system is devised for an entirely different venue and purpose and does not use the same methods of mechanics or design in it mounting system.

Thus the “Speaker Mounted on a Double Meridian Rotating Acoustic Mount” device is neither an aiming apparatus nor a speaker recesses in and/or fixture like, lighting enclosure pointing/aiming system. Thus this device incorporates the electrical connections to the proposed enclosure/speaker within each ring while permanently keeping its electrical connecting. Thus the “rotating Acoustical Bearing ring” uses rings strips that mount to the underside of a speaker and to the perimeter of the inner ring, to allow impulse driven sporadic movements. Therefore the industry needs a quick, simple, thin, rigid add-on ring that can be installed on any existing and/or pre-developed system, which can rotate in a forward and backward 90 degree angle and a forward and backward 180 degree angle and can or will house a combination of one or more speaker units. When agitation is generated by kinetic energy from the speaker vibrations, a swinging like motion performance occurs on its axis, due to powered being exerted through stereo system and/or amplifiers. The more power output by stereo/amplification system, into the speaker placed inside the ring rings, the more rotation increases in angular degrees.

### SUMMARY OF THE INVENTION

Disclosed is a device composed of several rotating rings or polygonal shapes designed to mount between an acoustical sound speaker and an enclosure or structure, allowing it to use kinetic energy to rotate freely. Designed for a stereo purpose as an add-on unit or pre-installed setup. Each ring can accommodate one or more speakers depending on interior diameter size and speaker exterior diameter size. Each ring can be used solely in or as part of a muti-setup display or a combination of multiple setups and adjoining configurations.

An ideal installation is preferred where the rings are placed in an enclosure adapted and configure for that particular speaker system. Where in volume sizes, port sizes, recessed and or channelized designs, have already had been pre-configured but not mandatory.

The polygonal ring shape helps in becoming well suited to almost any exiting speaker container. The Interior rings size can be adjusted to fit all standard sized speaker system. But can be modified to any shape i.e. rectangle, triangle, ellipse, various polygonal shapes, because once the inner ring is smaller the system can be fitted, which then makes it very compatible.

The rotating rings further provide enhanced speaker functionality effect that prior or typical rigid adaptation did not provide. This is accomplished by allowing the speaker to rotate on its own reconnaissance. Free rotating functionality disallows any suppression encompassed by rigid mounting practices therefore improving acoustic presence.

The unveil apparatus is an performing acoustic replicator of any design mounted within the polygonal or circular rings having an inner interior diameter smaller than the outer ring, Each rings axis's is bounded opposite of each other to allow different rotating patterns. Then it is secured inside another ring, which is then mounted on a cabinet or solid enclosure via any fastening device. The inner ring bears a circular opening, which is used to house a speaker unit(s). This opening typically resembles a circular from, but can be configured to any shape or form to co-exist on any irregular manufactured speaker system. The quadrant of the outer surface of both the inner and outer rings contains a Pin or Peg like structures that extrudes out the face of the each ring. This peg on inner ring allows the inner ring to mount to the outer ring, creating an axis point of rotation. This peg also contains the electrical wiring needed to keep the speaker(s) electrical connectivity during rotations. The Inner ring Peg, encompasses a channelized path for the negative and positive leads to surround its perimeter, and allow the connectivity to the speaker system through each layer towards the outer ring. The Outer ring Peg, encompasses a channel zed path for the negative and positive leads to surround its perimeter, and allow the connectivity to stereo supplying and output. Again this perimeter peg is secured between the outer and interior inner ring to a cabinet (or any variation) or enclosure via a fastening device. When completely installed the structure provides the speaker with self-inflicting rotating swings in its axis and or Pegs, when the speaker is in use. More variable rotations may be achieved by applying more power to system via amplifier or stereo outputs/inputs.

The objection of this information is to reveal a Double Meridian Rotating Acoustic Mounts apparatus, which can be used on all pre-existing speaker systems but can be configured into new modules, to reproduce an unmanned variable rotational effect. Therefore already using provided or thus to be provided power consumption for the acoustical device(s).

An additional objection of this device is to enhance aesthetics and visual looks due to its life like dance motions, which occur on a rhythmic manner as music is played.

Another objection in this development is to show the ease of installation and its compatibility to proposed and existing systems. Any existing systems speaker cabinets (enclosures) can be fitted to adapt to this rings. And converted to a self-spinning acoustical system.

Another distinction in these polygonal rings is to develop an uncomplicated system that maximizes a low frictional apparatus to execute known gravitational variables. Thus not foremost solely rely on stereo outputs/inputs but also environmental and gravitational changes to rotate the speaker unit.

Manufacturing is very simple due to its simple, and well used (in other applications) easily readily on stock comprised components, which makes it an inexpensive add on device to a stereo system.

These described devices, components, and objects will be detailed in drawings labeled FIG. 1-4 and more description as well as explanations will be conversed about the drawing.

### BRIEF DESCRIPTION OF THE DRAWINGS

FIG. 1 shows an isometric view of the “Double Meridian Rotating Acoustic Mounts” less speaker insertion.

FIG. 2 shows an plan view, of the “Double Meridian Rotating Acoustic Mounts” showing ring like object, pegs, and the combination there of.

FIG. 3 shows a section view of view of the electrical system enclosed within the “Double Meridian Rotating Acoustic Mounts”.

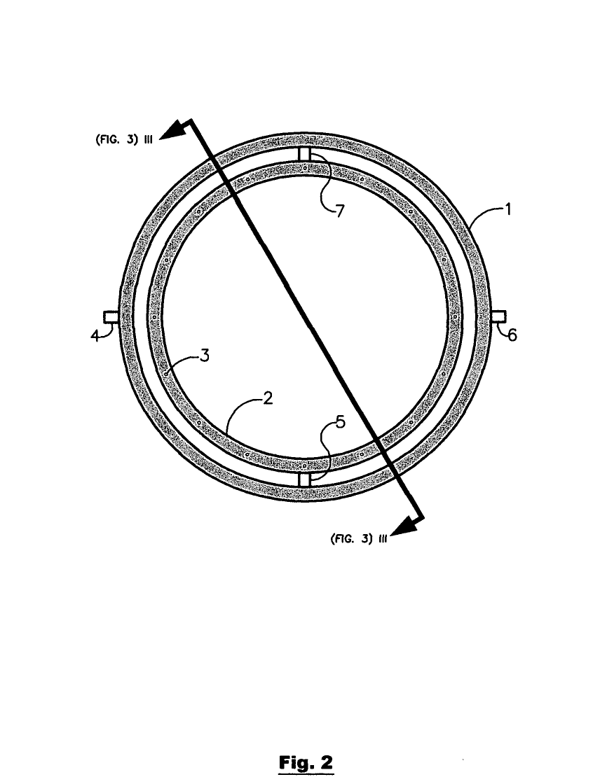

FIG. 2 shows an isometric view of the “Double Meridian Rotating Acoustic Mounts” with speaker insertion.

### DETAILED DESCRIPTION OF THE MENTIONED FIGURES

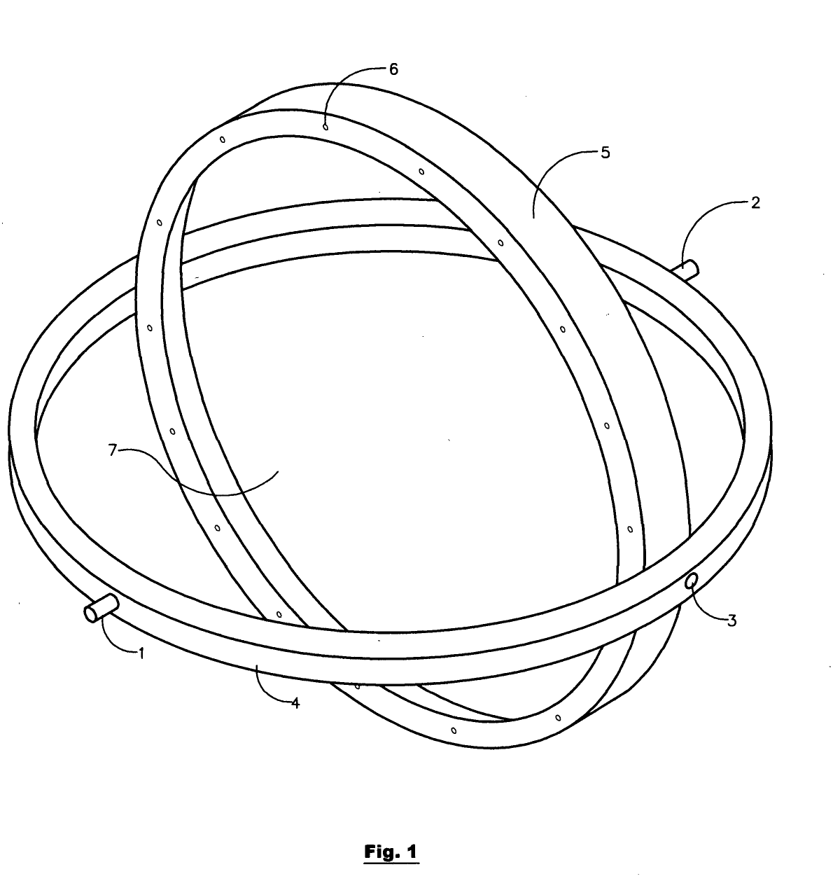

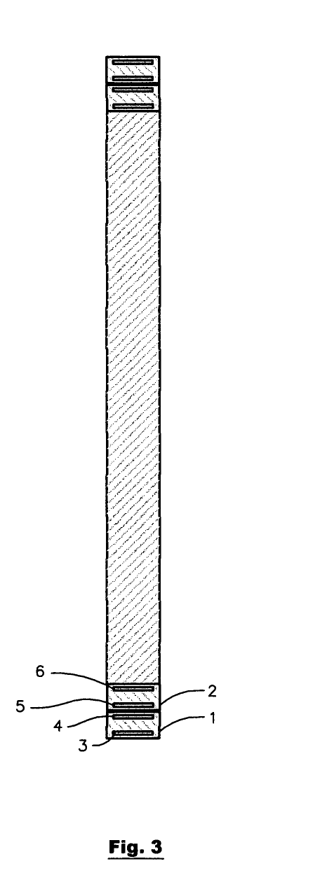

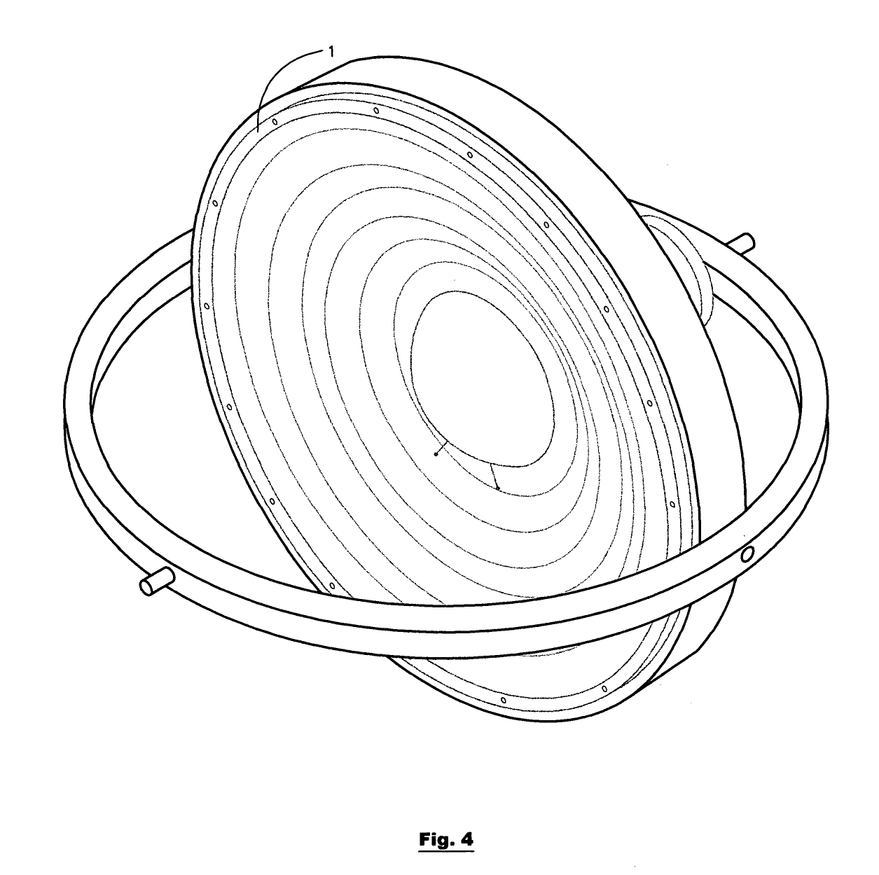

FIG. 1 shows an isometric view of the assembly of a Double Meridian Rotating Acoustic Mounts. The pegs 1, 2 both left and right mounted on the outer ring 4 serves two functions. Its first function acts like a rotating axis point that will be mounted on the enclosure. The second is to encompass both a negative and positive lead which then will connect to the amplifier or stereo output via cabling. The outer ring 4 connects to the inner circular ring 5 via another two pegs 3, FIG. 2 callout 4 both left and right mounted on the inner ring 5 and is cradled by the outer ring 4 which serves three functions. The first function acts like a rotating axis point that can and will be mounted on the outer ring 4. The second is to encompass both a negative and positive leads which then will connect to the negative and positive leads in the outer ring 4. The Inner ring 5 houses an audio speaker device FIG. 4 callout 1. This is made possible by the opening that is placed within the inner ring 5. This opening 7 is of the form of a circular diameter but can be any irregular or polygonal shape needed to encompass the acoustic speaker. The Inner ring 5 contains screw holes 6 that go through the body allowing firm installation of the speaker FIG. 4 callout 1 to the inner ring 5. The inner circular ring 5 then houses the speaker(s) FIG. 4 callout 1 which obtains an electrical signal through the inner rings 5 negative and positive leads which then can operate in a normal matter when in rotating movements because of its rings. An alternate configuration can be achieved but not shown where the ring 5 can also be mounted with several speakers FIG. 4 callout 1. This would imply that the channelized pathway that is currently shown on FIG. 3 callout (3, 4, 5, 6) would now be doubled or tippled in the given application scenario. Also the inner ring 5 can have an irregular opening 7 cutout which can encompass the irregular or polygonal shape speaker. Again it is not necessary in the design of the invention that the holes 6 within the inner ring 5 or the speaker FIG. 4 callout 1 be round, nor is it necessary that the inner circle 5 of the inner ring FIG. 4 callout 1 house one speaker. Thus an alternate version is theoretically possible in which more than one speaker can be used in the internal ring 5 as a multiple speaker combination or multiple speaker sizes or inner rings 5.

FIG. 2 shows a plan view of the “Double Meridian Rotating Acoustic Mounts” less speaker adaptation. Also a cross sectional line is drawn through the assembly and described in FIG. 3. The view depicts the assembly of the two rings 1, 2. The outer ring 1 and the inner ring 2. These rings perform various tasks. The diameter of the outer ring 1 is calculated after the inner ring 2 is known. The inner ring 2 is calculated after the speaker size FIG. 4 callout 1 is anticipated allowing plus inches for the mounting screws and nuts that access through the holes 3 on the inner ring 2. The outer ring 1 and the inner ring 2 widths are calculated after knowing the devices wattage and power handling capacity, depth should be added to accommodate higher wattage speakers, with grater handling loads. This view also shows the inner circular ring 2 screw holes 3 that go through the body allowing firm installation onto the speaker apparatus FIG. 4 callout 1. The outer circular ring 1 also has the peg like structure 4, 6 that allows firm installation of the complete apparatus as well as electrical connectivity. The electrical connectivity is housed within each ring 1, 2. The inner ring 2 houses two electrical conduits around its perimeter that completes the circuit to the given speaker unit. The outer ring 1 has identical channalized conduits that connects to the inner ring 2 through peg 5, 7. In turn the connectivity in ring 1 is supplied by pegs 4, 6. These pegs 4,5,6,7 performs multi functions, these pegs 4, 5, 6, 7 acts as a rotating axis point that between the two rings and between the rings and the enclosure. The second function of pegs 4,5,6,7 is to encompass both a negative and positive leads which then will connect between the rings and to the Amplifier or stereo output via cabling. The outer ring 1 connects to the inner circular ring 2 via pegs 5, 7. Both these pegs are mounted on the inner ring 2 and are cradled by the outer ring 1. There purpose is to acts like a rotating axis point and a securing mounting point that supported on the outer ring 1. The second is to encompass both a negative and positive leads which then will connect to the negative and positive leads in the outer ring 1. Therefore the electric continuation is connected through all these items completing the circuit.

FIG. 3 shows a section view of FIG. 2. This view shows the internal electrical methods for supplying the internal audio speaker with a continuous and supply of power while in rotations. The inner ring 2 and the outer ring 1 contain identical internal channelized conduits 3, 4, 5, 6. These internal channelized paths contain conductive materials to house either a negative and positive voltage to the internal acoustic speaker(s) that's sits within the inner ring 2. The electrical signals (negative and positive) flows from the outermost peg FIG. 2 callout 4, 6 then connects to the internal ring 2 outer ring. From there the channelized paths of any shape and configuration 3, 4 surround the ring 1 with power. From there the power is routed to the inner ring 2, through the inner pegs FIG. 2 callouts 5, 7. From there the channelized paths 5, 6 surrounds the ring 2 with power. That power is then connected to the internal audio speaker FIG. 4 callout 1. This electrical connection is made through the rotating pegs that house the conduits but rotates as well. These apparatus sizes will directly relate to weight of speaker unit and system vibration foreseen that the output will reproduce. Total speaker wattage and load capacity will dictate a stretching of the outer 1 ring and inner ring 2. Also the channelized conduits can be increased in size and material to accommodate an increase in size or a more robust apparatus.

FIG. 4 shows the FIG. 1 with all its components with the insertion of a speaker 1 (Subwoofer, Woofer, Mid-range, High-range or a combination there of), which completes the apparatus.

Ring quantity can be increased to also aid in the accommodations of more interior rings. Material type can also be modified into various types of plastic, synthetic materials non-metallic or metallic compounds or a combination of thereof. Different types of shapes or variation plus combination thereof can be substituted or implemented in this design.

Speaker adaptation can vary from circle diameter modules, rectangular modules, triangular modules, and polygonal modules.

Speaker types can me retrofitted, form subwoofer assemblies to woofer assemblies, and or any other speaker console therefore.

Description shows how individual components can be arranged to utilized and allow interior speaker to free flow on its own kinetic energy generated by sound input/output, by outer and inner ring(s). The speaker will be mounted firmly within the inner most ring(s) with nut and bolt assembly or screw type attachments (which is not shown) so attachment will slip through said hole's FIG. 2 callout 3. The outer most rings will be mounted on an enclosure type through pegs FIG. 2 callout 4, 6. Making rings 1, 2 operate on variable rotating axis when power is applied to speaker(s).

Description shows how individual components can be rearranged to work in a like manner. Channelized paths FIG. 3 callouts 3, 4, 5, and 6 can be reverted to different planes. For example channelized paths can be reverted to a vertical alignment within ring FIG. 3 callout 1, 2. So it can operate on variable rotations along axis's when power is applied to speaker.

“Less enclosure” means less embodiment close or open synthetic or wooded housing. Per detail description above, much emphasis was not made on enclosure type, size or shape. Since the rotating ring is made as an add-on supplemental kit. Mention to enclosure type has no impact. Meaning ring can be added on to any existing or NEW enclosures to achieve kinetic movements form the speaker when amplification or typical stereo system applies power.

Environment was also not taken into account due to ring being an add-on supplemental kit. Meaning enclosure calculations is not needed on pre-existing speaker to enclosure systems after already calculated enclosure sizes and specs have been calculated. After then adaptation installation can begin.

Kinetic energy has been stated meaning power or force exerted to speaker system thus allows speaker, woofer, sub-woofer, or any acoustical replicator to vibrate. Vibration then allows unit to spin or be agitated in a life like form when music is played being that rotating allows speaker to move.

Acoustical replicator has been generated throughout patent describes, and specifications. Acoustical replicator generally means speaker unit, or any speaker unit that generates audio sounds via electronic signals processed and reproduced as known as sound.

While this invention has been described expressively above. With said attachments and configurations, it is to be unwritten that the invention is not limited to the exact descript, but is anticipated to cover assorted modifications, variations and or similar concepts within the span of the claims descriptions.

What I claim as my invention:

1. An attachable multi polygonal or ring like object inserted into any structure, allowing a sound emitter and or speaker(s) to rotate freely within its inner perimeter that consist of:
An outer polygonal shape(s) or circular ring(s) having a Peg like attachable mount;
Peg like attachable mount structures to aid in rotation and supply electrical connectivity between said outer ring and enclosure;
An inner circular ring(s) having another pair of peg structures to mount to said outer circular ring(s);
Peg like structures to aid in rotation and supply electrical connectivity between said outer ring(s) and inner ring(s);
The combination of said inner, outer circular ring(s), and Peg like attachable mounts to comprise into functional rotating ring(s);

2. Apparatus as described in claim one above further comprising:
An acoustical sound emitter(s) fastens in said inner circular rotating ring(s);

3. The device as described in claim one and two above wherein said outer circular ring(s) and said inner circular ring(s) and with but not obligatory said acoustical sound generator, have a rotating disposition on any rotating degrees.

4. The mechanism as described in claim three above can encompass the adding of the mounts on a pre-existing or proposed design application.

5. The mechanism as described in claim four above provided double unregulated variable rotations on its axis from its environment.

6. The combinational effort reproduced, allows sound waves to gyrate sporadically outwards using its kinetic energy.

7. Said unregulated variable rotations allow waves to enhance sound effects.
